(19) United States
(12) Patent Application Publication
(10) Pub. No.: US 2023/0016935 A1
(43) Pub. Date: Jan. 19, 2023

(54) COMMUNICATION DEVICE, WIRELESS POWER SUPPLYING DEVICE, COMMUNICATION METHOD, AND COMPUTER-READABLE STORAGE MEDIUM

(71) Applicant: TOYOTA JIDOSHA KABUSHIKI KAISHA, Toyota-shi (JP)

(72) Inventors: Isao WATANABE, Nagoya-shi (JP); Kanade KURIYAMA, Toyota-shi (JP)

(73) Assignee: TOYOTA JIDOSHA KABUSHIKI KAISHA, Toyota-shi (JP)

(21) Appl. No.: 17/810,731

(22) Filed: Jul. 5, 2022

(30) Foreign Application Priority Data
Jul. 14, 2021 (JP) 2021-116669

(51) Int. Cl. H02J 50/80; H02J 50/70

(52) U.S. Cl. CPC H02J 50/80; H02J 50/70

(57) ABSTRACT

A communication device is installed in a vehicle. The communication device includes: a first communication section communicating with an interior of a vehicle; a second communication section communicating with an exterior of the vehicle; and a controller carrying out control such that communication by the first communication section and communication by the second communication section do not overlap Due thereto, peaks in an amount of power consumed by the communication device can be suppressed, and compactness of a built-in battery that is provided in the communication device can be realized.

### CROSS-REFERENCE TO RELATED APPLICATION

This application is based on and claims priority under 35 USC § 119 from Japanese Patent Application No. 2021-116669 filed on Jul. 14, 2021, the disclosure of which is incorporated by reference herein.

### TECHNICAL FIELD

The present disclosure relates to a communication device, a wireless power supplying device, a communication method, and a computer-readable storage medium that stores a communication program.

### RELATED ART

The wireless communication device disclosed in Japanese Patent Application Laid-Open (JP-A) No. 2018-125622 (Patent Document 1) has a receiver, a controller, and a transmitter. The receiver receives first requests transmitted from at least some of plural first wireless communication devices. The controller selects two or more first wireless communication devices from the first wireless communication devices that transmitted the first requests, among the plural first wireless communication devices. The transmitter transmits a first frame that instructs execution of multiplex transmission to the first wireless communication devices that the controller selected.

In order to realize a connected vehicle, a communication architecture that acquires various data from the vehicle and transmits the acquired data to a server is needed. In a vehicle in which a DCM (Data Communication Module) is not installed, a communication device is installed afterwards. A receiving antenna for television broadcasts, an onboard unit of an ETC (Electronic Toll Collection system), and the like are installed on the front windshield of a vehicle. Therefore, the upper section of the rear windshield of the vehicle is an excellent installation position in a case in which a communication device is provided afterwards. However, the periphery of the rear windshield of the vehicle is a movable portion that is displaced accompanying the opening and closing of the back door of the vehicle, and installation space thereat also is limited. Therefore, there is the need for a structure that can suppress the amount of power that is consumed, and particularly peaks thereof, in order to reduce the size and the like of the communication device.

### SUMMARY

The present disclosure has been made in consideration of the above-described circumstances, and an object thereof is to provide a communication device, a communication method, and a computer-readable storage medium that stores a communication program, which can suppress peaks in the amount of consumed power.

Another object of the present disclosure is to provide a wireless power supplying device that can compensate for a decrease in the amount of power that is accumulated in a built-in battery of a communication device during a time period in which the ignition switch of a vehicle is off.

A communication device relating to a first aspect is installed in a vehicle and includes: a first communication section communicating with an interior of a vehicle; a second communication section communicating with an exterior of the vehicle; and a controller carrying out control such that communication by the first communication section and communication by the second communication section do not overlap.

In the first aspect, control is carried out such that communication with the interior of the vehicle by the first communication section and communication with the exterior of the vehicle by the second communication section do not overlap. Due thereto, peaks in the amount of power consumed by the communication device can be suppressed. Further, in a case in which a built-in battery is provided in the communication device, compactness of the built-in battery can be realized.

In a second aspect, in the first aspect, the communication device is installed at a movable portion of the vehicle, the first communication section carries out wireless communication with the interior of the vehicle, and the second communication section carries out wireless communication with the exterior of the vehicle.

In accordance with the second aspect, wiring for communication by the first communication section and communication by the second communication section can be omitted.

In a third aspect, the first aspect or the second aspect further includes: a wireless power receiver that receives power wirelessly from the interior of the vehicle; and a built-in battery that accumulates power received by the wireless power receiver, and supplies power to the first communication section, the second communication section, and the controller.

In accordance with the third aspect, wiring for receiving power can be omitted.

In a fourth aspect, in the third aspect, the controller causes communication to be carried out by the second communication section, after communication is carried out by the first communication section and the wireless power receiver receives power.

In accordance with the fourth aspect, it is possible to have communication by the second communication section be carried out after recovery from the decrease in the amount of power accumulated in the built-in battery that accompanies communication by the first communication section.

In a fifth aspect, in the fourth aspect, the controller causes communication to be carried out by the second communication section, after the first communication section carries out communication, and the wireless power receiver receives power, and it is confirmed that voltage of the built-in battery is greater than or equal to a first predetermined value.

In accordance with the fifth aspect, communication by the second communication section can be made to be carried out stably.

In a sixth aspect, in any one of the first aspect through the fifth aspect, the controller transitions to a power-saving mode during a time period in which communication by the first wireless communication section and communication by the second wireless communication section are not carried out.

In accordance with the sixth aspect, the amount of power consumed by the communication device can be reduced.

A wireless power supplying device relating to a seventh aspect includes a wireless power supplying section that intermittently supplies power to the communication device of any of the third aspect through the fifth aspect, from a battery of the vehicle during a time period in which an ignition switch of the vehicle is off.

In accordance with the seventh aspect, it is possible to compensate for a decrease in the amount of power accumulated in the built-in battery of the communication device during the time period in which the ignition switch of the vehicle is off.

In an eighth aspect, in the seventh aspect, in a case in which voltage of the battery of the vehicle is less than a second predetermined value, the wireless power supplying section stops supplying power to the communication device.

In accordance with the eighth aspect, the battery of the vehicle going dead, which accompanies supplying of power to the communication device, can be suppressed.

A communication method relating to a ninth aspect causes a computer to, in a communication device installed in a vehicle, execute processings including carrying out control such that communication by a first communication section, which carries out communication with an interior of the vehicle, and communication by a second communication section, which carries out communication with an exterior of the vehicle, do not overlap.

In accordance with the ninth aspect, in the same way as in the first aspect, peaks in the amount of consumed power of the communication device can be suppressed.

A computer-readable storage medium relating to a tenth aspect stores a communication program that causes a computer to, in a communication device installed in a vehicle, execute processings including carrying out control such that communication by a first communication section, which carries out communication with an interior of the vehicle, and communication by a second communication section, which carries out communication with an exterior of the vehicle, do not overlap.

In accordance with the tenth aspect, in the same way as in the first aspect, peaks in the amount of power consumed by the communication device can be suppressed.

The present disclosure has the effect of being able to suppress peaks in the amount of consumed power of a communication device.

Moreover, the present disclosure has the effect of being able to compensate for a decrease in the amount of power accumulated in a built-in battery of a communication device during a time period in which the ignition switch of a vehicle is off.

### BRIEF DESCRIPTION OF THE DRAWINGS

FIG. 1 is a block drawing illustrating the schematic structures of a communication device and a wireless power supplying ECU.

FIG. 2 is a functional block drawing of a microcomputer of the communication device.

FIG. 3 is a flowchart illustrating communication processing executed by the microcomputer of the communication device.

FIG. 4 is a sequence diagram illustrating the sequence of communication/power supplying in a case in which an ignition switch of a vehicle is switched on.

FIG. 5 is a sequence diagram illustrating the sequence of communication/power supplying in a case in which the communication device transitions to a power-saving mode.

FIG. 6 is a flowchart illustrating wireless power supplying processing executed by a wireless controller of the wireless power supplying ECU.

FIG. 7 is a sequence diagram illustrating the sequence of power supplying when the ignition switch of the vehicle is on and when the ignition switch of the vehicle is off.

FIG. 8 is a block drawing illustrating schematic structures of another example of the communication device and the wireless power supplying ECU.

### DETAILED DESCRIPTION

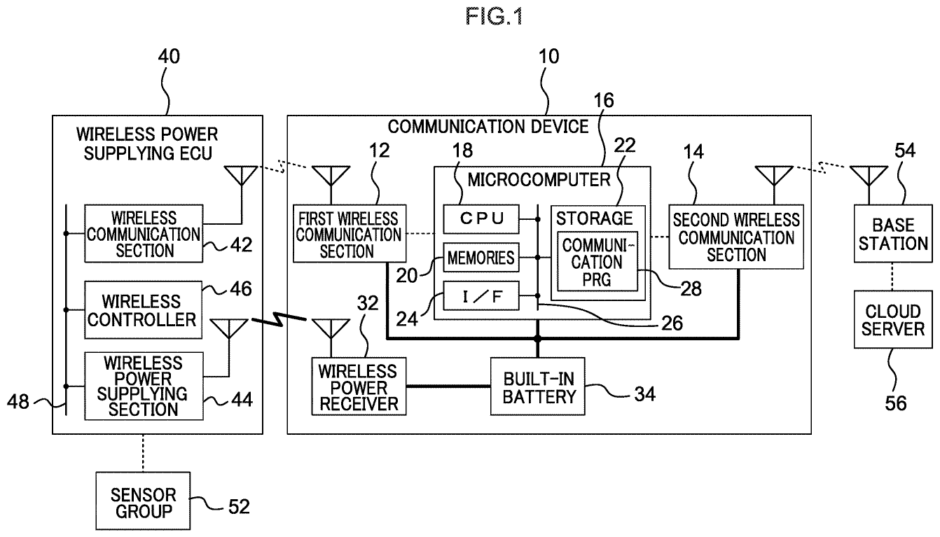

Examples of exemplary embodiments of the present disclosure are described in detail hereinafter with reference to the drawings. A communication device 10 and a wireless power supplying ECU (Electronic Control Unit) 40 are illustrated in FIG. 1. The communication device 10 and the wireless power supplying ECU 40 are units that are additionally installed into a vehicle in which a DCM is not installed, in order to enable communication with a cloud server 56 through a base station 54 connected to the cloud server 56. Note that a back door is provided at the vehicle. The communication device 10 is installed at the back door side, and more specifically, at the periphery of the upper portion of the rear windshield. The wireless power supplying ECU 40 is installed in a vicinity of the communication device 10 at the vehicle body side. Note that the back door is an example of the movable portion of the vehicle.

The communication device 10 includes a first wireless communication section 12 (e.g., communication circuitry), a second wireless communication section 14 (e.g., communication circuitry), a microcomputer 16, a wireless power receiver 32 (e.g., receiver circuitry), and a built-in battery 34. The first wireless communication section 12 carries out wireless communication with the interior of the vehicle, and specifically, with the wireless power supplying ECU 40, and receives onboard information from the wireless power supplying ECU 40, and transmits this information to the microcomputer 16. The first wireless communication section 12 is an example of the first communication section in the present disclosure.

The second wireless communication section 14 carries out wireless communication with the exterior of the vehicle, and specifically, with the cloud server 56, and transmits the onboard information received from the microcomputer 16 to the cloud server 56. Note that, for example, an LPWA (Low Power Wide Area network, also called LPWAN) can be used for the wireless communication between the second wireless communication section 14 and the cloud server 56.

The second wireless communication section 14 is an example of the second communication section in the present disclosure.

The microcomputer 16 includes a CPU (Central Processing Unit) 18, memories 20 such as a ROM (Read Only Memory), a RAM (Random Access Memory) and the like, and a non-volatile storage section 22 such as an HDD (Hard Disk Drive), an SSD (Solid State Drive) or the like.

Further, the microcomputer 16 includes an I/F (InterFace) section 24.
The CPU18, the memories 20, the storage section 22 and the I/F section 24 are connected so as to be able to communicate with one another through an internal bus 26.

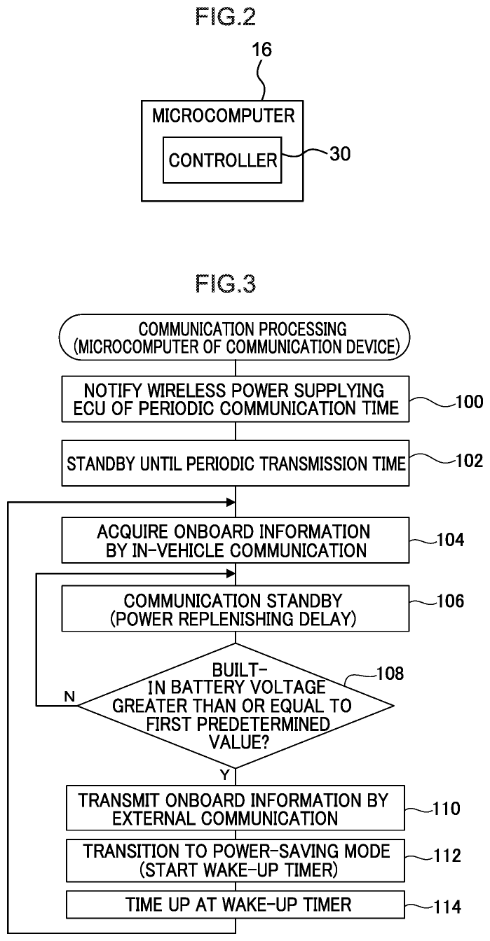

The storage section 22 stores a communication program 28. The microcomputer 16 functions as a controller 30 illustrated in FIG. 2 due to the communication program 28 being read-out from the storage section 22 and expanded in the memory 20, and the communication program 28 that has been expanded in the memory 20 being executed by the CPU 18. The controller 30 effects control such that the wireless communication carried out by the first wireless communication section 12 and the wireless communication carried out by the second wireless communication section 14 do not overlap. Note that the communication program 28 is an example of the communication program relating to the present disclosure.

The wireless power receiver 32 receives power that is supplied wirelessly from the wireless power supplying ECU 40, and supplies the received power to the built-in battery 34. Moreover, the built-in battery 34 accumulates the power that is supplied from the wireless power receiver 32, and supplies accumulated power to the first wireless communication section 12, the microcomputer 16, and the second wireless communication section 14. In the present exemplary embodiment, because the installation space for the communication device 10 is limited, a compact, lightweight battery such as a capacitor is desirably used as the built-in battery 34.

The wireless power supplying ECU 40 includes a wireless communication section 42, a wireless power supplying section 44 (e.g., power supplying circuitry), and a wireless controller 46 (e.g., controlling circuitry). The wireless communication section 42, the wireless power supplying section 44, and the wireless controller 46 are connected so as to be able to communicate with one another through an internal bus 48. The wireless power supplying ECU 40 is connected to a sensor group 52 that includes plural types of sensors that are installed in the vehicle. Note that examples of the sensors included in the sensor group 52 are a vehicle speed sensor, an acceleration sensor, a steering angle sensor, an accelerator pedal sensor, a brake pedal sensor, a GNSS (Global Navigation Satellite System) sensor, and the like.

The wireless communication section 42 collects onboard information from the sensor group 52, and wirelessly transmits the collected onboard information to the communication device 10. The wireless power supplying section 44 wirelessly supplies power to the communication device 10. The wireless controller 46 is formed by a microcomputer that includes a CPU, a memory, a non-volatile storage section, and the like, and controls the operations of the wireless communication section 42 and the wireless power supplying section 44. Note that the wireless power supplying ECU 40 is an example of the wireless power supplying device relating to the present disclosure, and the wireless power supplying section 44 and the wireless controller 46 are examples of the wireless power supplying section in the present disclosure.

On the other hand, the cloud server 56 wirelessly receives onboard information from individual vehicles via the base station 54, and stores the received onboard information in a storage or the like. The cloud server 56 then carries out processings to provide predetermined services to unillustrated client terminals or the like based on the onboard information stored in the storage or the like. Examples of predetermined services provided by the cloud server 56 include an operation management information providing service that generates and provides operation management information that displays the positions, vehicle speeds, and the like of individual vehicles on a map.

Next, communication processing, which is executed by the microcomputer 16 of the communication device 10 while the ignition switch of the vehicle is on, is first described as the operation of the present exemplary embodiment with reference to FIG. 3.

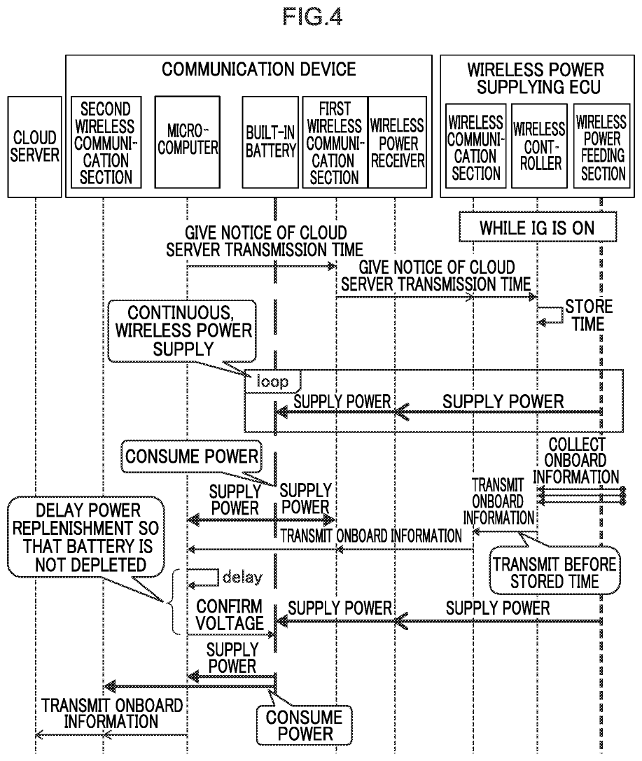

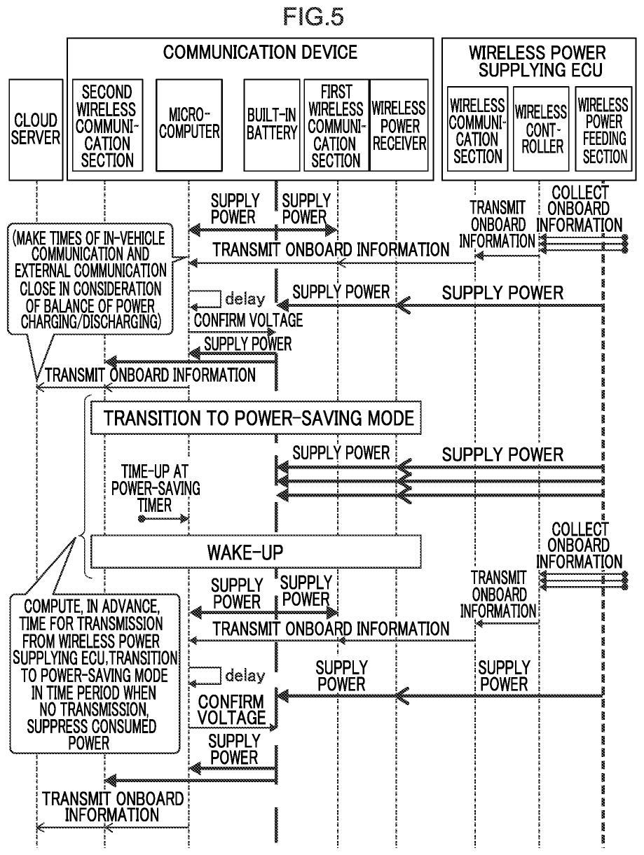

In the present exemplary embodiment, onboard information is periodically transmitted from the vehicle to the cloud server 56 while the ignition switch of the vehicle is on. In step 100, the controller 30 notifies the wireless power supplying ECU 40 of the time of the periodic communication of the onboard information from the vehicle to the cloud server 56. This notification is transmitted from the microcomputer 16 to the wireless communication section 42 via the first wireless communication section 12 by wireless communication as shown by “give notice of cloud server transmission time” in FIG. 4, and thereafter, is received by the wireless controller 46. Then, the wireless controller 46 stores the notified time in a memory or the like.

In step 102, the controller 30 stands-by until the time of the periodic transmission of the onboard information to the cloud server 56 arrives. During this time, as shown by “continuous, wireless power supply” in FIG. 4, the wireless power supplying section 44 of the wireless power supplying ECU 40 continuously feeds power wirelessly to the wireless power receiver 32 of the communication device 10, and the power that the wireless power receiver 32 receives from the wireless power supplying section 44 is accumulated in the built-in battery 34. Further, as shown by “consume power” in FIG. 4, when power consumption arises at the microcomputer 16 and the first wireless communication section 12, power is supplied from the built-in battery 34 to the microcomputer 16 and the first wireless communication section 12.

Moreover, at a time that is a predetermined time before the time of the periodic communication of the onboard information to the cloud server 56, the wireless controller 46 of the wireless power supplying ECU 40 collects onboard information from the sensor group 52, as shown by “collect onboard information” in FIG. 4. Then, in step 104, the controller 30 acquires onboard information from the wireless power supplying ECU 40 by in-vehicle communication with the wireless power supplying ECU 40. Namely, the wireless controller 46 transmits the onboard information collected from the sensor group 52 to the first wireless communication section 12, as shown by “transmit before stored time” in FIG. 4. Further, the first wireless communication section 12 transmits the onboard information received from the wireless controller 46 to the controller 30 (the microcomputer 16).

In step 106, the controller 30 temporarily stands-by for communication with the cloud server 56 in order to replenish power to the built-in battery 34 (refer also to “delay power replenishment so that battery is not depleted” shown in FIG. 4). In step 108, the controller 30 judges whether or not the voltage of the built-in battery 34 is greater than or equal to a first predetermined value. In a case in which the determination in step 108 is negative, processing returns to step 106, and the state of temporarily standing-by for communication with the cloud server 56 continues.

During this time, as shown by “supply power” in FIG. 4, the wireless power supplying section 44 of the wireless power supplying ECU 40 wirelessly feeds power to the wireless power receiver 32 of the communication device 10, and the power that the wireless power receiver 32 receives from the wireless power supplying section 44 is accumulated in the built-in battery 34. In this way, when the voltage of the built-in battery 34 becomes greater than or equal to the first predetermined value, the determination of step 108 is affirmative, and processing proceeds to step 110.

In step 110, the controller 30 transmits onboard information to the cloud server 56 by external communication with the cloud server 56. Namely, the controller 30 (the microcomputer 16) transmits the onboard information acquired from the wireless power supplying ECU 40 to the second wireless communication section 14. Further, the second wireless communication section 14 transmits the onboard information received from the controller 30 (the microcomputer 16) to the cloud server 56. In this way, the controller 30 effects control such that the communication carried out by the first wireless communication section 12 and the communication carried out by the second wireless communication section 14 do not overlap.

In step 112, based on the time of the periodic communication of the onboard information to the cloud server 56, the controller 30 calculates the time at which onboard information is to be received next from the wireless power supplying ECU 40. Then, the time period to be clocked by the timer is decided upon, and the timer is started so that the communication device 10 will be restored from the power-saving mode at the calculated time, and the communication device 10 is made to transition to the power-saving mode (refer also to “transition to power-saving mode” shown in FIG. 5). Due thereto, the amount of power that is consumed by the communication device 10 is suppressed.

Note that, in the present exemplary embodiment, the time difference between the time at which the controller 30 receives onboard information from the wireless power supplying ECU 40 and the time at which the controller 30 transmits the onboard information to the cloud server 56 is made to be as short as possible in consideration of the balance of the charging and discharging of the built-in battery 34. Due thereto, the time over which the communication device 10 transitions to the power-saving mode can be lengthened, and the amount of power consumed by the communication device 10 can be further suppressed.

On the other hand, while the communication device 10 is in the power-saving mode, as shown by “supply power” in FIG. 5, the wireless power supplying section 44 of the wireless power supplying ECU 40 wirelessly feeds power to the wireless power receiver 32 of the communication device 10, and the power that the wireless power receiver 32 receives from the wireless power supplying section 44 is accumulated in the built-in battery 34. Due thereto, after the power-saving mode is cancelled, the communication device 10 can immediately receive onboard information from the wireless power supplying ECU 40.

As shown in step 114, when the time being clocked by the timer is up, the controller 30 carries out wake-up processing to restore the communication device 10 from the power-saving mode. Then, processing returns from step 114 to step 104, and the processings from step 104 onward are repeated.

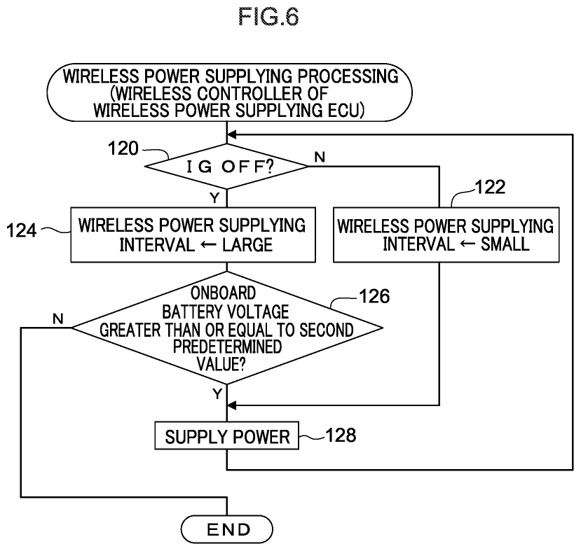

The wireless power supplying processing executed by the wireless controller 46 of the wireless power supplying ECU 40 is described next with reference to FIG. 6. In step 120, the wireless controller 46 judges whether or not the ignition switch of the vehicle is off. In a case in which the ignition switch of the vehicle is on, the judgment in step 120 is negative, and processing moves on to step 122. In step 122, the wireless controller 46 sets a relatively small value as the wireless power supplying interval, and processing moves on to step 128.

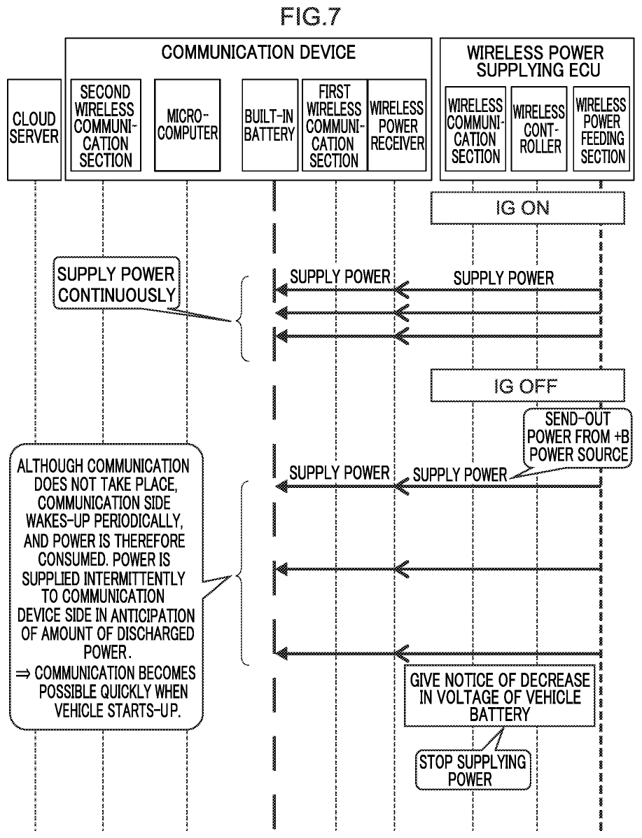

In step 128, the wireless controller 46 wirelessly feeds power from the wireless power supplying section 44 to the wireless power receiver 32 of the communication device 10 at a relatively short time interval in accordance with the the wireless power supplying interval that was set in step 122, as shown by “supply power continuously” in FIG. 7. The power that the wireless power receiver 32 receives from the wireless power supplying section 44 is accumulated in the built-in battery 34.

On the other hand, in a case in which the ignition switch of the vehicle is off, the judgment in step 120 is affirmative, and processing moves on to step 124. In step 124, the wireless controller 46 sets a value, which is larger than that in the case in which the ignition switch of the vehicle is on, as the wireless power supplying interval. In next step 126, the wireless controller 46 judges whether or not the voltage of an onboard battery is greater than or equal to a second predetermined value.

In a case in which the judgment in step 126 is affirmative, processing moves on to step 128. In step 128, the wireless controller 46 wirelessly feeds power from the wireless power supplying section 44 to the wireless power receiver 32 of the communication device 10 at a time interval that is longer than that in the case in which the ignition switch of the vehicle is on, in accordance with the wireless power supplying interval that was set in step 124. The power that the wireless power receiver 32 receives from the wireless power supplying section 44 is accumulated in the built-in battery 34.

Although communication does not occur while the ignition switch of the vehicle is off, the communication device 10 side periodically wakes up and therefore consumes power. Therefore, in the present exemplary embodiment, while the ignition switch of the vehicle is off, power is supplied intermittently as described above in anticipation of the amount of discharging of the built-in battery 34. Due thereto, communication can be carried out quickly when the ignition switch of the vehicle is switched on.

Moreover, because charging of the onboard battery is not carried out while the ignition switch of the vehicle is off, the amount of power accumulated in the onboard battery gradually decreases as power is supplied to the communication device 10. When the voltage of the onboard battery has become less than the second predetermined value, the judgment in step 126 is negative, and the wireless power supply processing is ended, thereby stopping the supply of power to the communication device 10. Due thereto, the onboard battery can be prevented in advance from being depleted and falling into a state in which starting of the vehicle is difficult.

As described above, in the present exemplary embodiment, the communication device 10 is installed in a vehicle. Further, the communication device 10 includes the first wireless communication section 12 that communicates with the interior of the vehicle, the second wireless communication section 14 that communicates with the exterior of the vehicle, and the controller 30 that effects control such that communication by the first wireless communication section 12 and communication by the second wireless communication section 14 do not overlap.

Due thereto, peaks in the amount of power that is consumed by the communication device 10 can be suppressed, and compactness of the built-in battery 34 that is provided in the communication device 10 can be realized.

Moreover, in the present exemplary embodiment, the communication device 10 is installed at a movable portion of a vehicle, the first wireless communication section 12 carries out wireless communication with the interior of the vehicle, and the second wireless communication section 14 carries out wireless communication with the exterior of the vehicle. Due thereto, wiring for communication by the first wireless communication section 12 and communication by the second wireless communication section 14 can be omitted.

Moreover, in the present exemplary embodiment, the communication device 10 further includes the wireless power receiver 32 that wirelessly receives power from the interior of the vehicle, and the built-in battery 34 that accumulates the power received by the wireless power receiver 32 and supplies power to the first wireless communication section 12, the second wireless communication section 14, and the controller 30. Due thereto, wiring for receiving power can be omitted.

Moreover, in the present exemplary embodiment, the controller 30 causes communication to be carried out by the second wireless communication section 14, after communication is carried out by the first wireless communication section 12 and the wireless power receiver 32 has received power. Due thereto, it is possible to have communication by the second wireless communication section 14 be carried out after recovery from the decrease in the amount of power accumulated in the built-in battery 34 that accompanies communication by the first wireless communication section 12.

Moreover, in the present exemplary embodiment, the controller 30 causes communication by the second wireless communication section 14 to be carried out, after communication by the first wireless communication section 12 is carried out, and the wireless power receiver 32 receives power, and it is confirmed that the voltage of the built-in battery 34 is greater than or equal to a first predetermined value. Due thereto, the communication by the second wireless communication section 14 can be made to be carried out stably.

Moreover, in the present exemplary embodiment, the controller 30 transitions to the power-saving mode during a time period in which communication by the first wireless communication section 12 and communication by the second wireless communication section 14 are not carried out. Due thereto, the amount of power consumed by the communication device 10 can be reduced.

Moreover, in the present exemplary embodiment, the wireless power supplying ECU 40 includes the wireless power supplying section 44 that intermittently supplies power to the communication device 10 from an onboard battery of the vehicle during a time period in which the ignition switch of the vehicle is off. Due thereto, it is possible to compensate for the decrease in the amount of power accumulated in the built-in battery 34 of the communication device 10 during the time period in which the ignition switch of the vehicle is off.

Moreover, in the present exemplary embodiment, in a case in which the voltage of the onboard battery of the vehicle is less than the second predetermined value, the wireless power supplying section 44 stops supplying power to the communication device 10. Due thereto, the onboard battery of the vehicle going dead, which accompanies supplying of power to the communication device 10, can be suppressed.

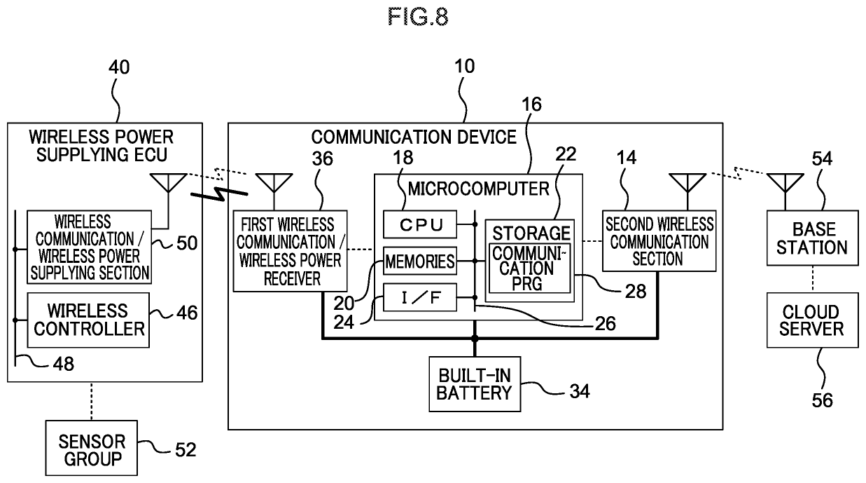

Although the above exemplary embodiment describes a form in which the first wireless communication section 12 and the wireless power receiver 32 of the communication device 10 are provided separately, the present disclosure is not limited to this. There are known modules that have the function of carrying out wireless communication simultaneously with wireless power supplying. As an example, as illustrated in FIG. 8, a first wireless communication/wireless power receiver 36 may be provided instead of the first wireless communication section 12 and the wireless power receiver 32 of the communication device 10, and a wireless communication/wireless power supplying section 50 may be provided instead of the wireless communication section 42 and the wireless power supplying section 44 of the wireless power supplying ECU 40. The present disclosure is also applicable to the structure illustrated in FIG. 8.

Although the above exemplary embodiment describes a form in which the communication device 10 is provided at the back door, which is an example of the movable portion, of a vehicle, the present disclosure is not limited to this. For example, the communication device 10 may be provided at another movable portion such as an outer mirror of a vehicle, or the like.

Moreover, the above exemplary embodiment describes a form in which the communication program 28, which is an example of the communication program relating to the present disclosure, is stored in advance (is installed) in the storage section 22. However, the communication program relating to the present disclosure may be provided in a form of being recorded on a non-transitory recording medium such as an HDD, an SSD, a DVD or the like.

What is claimed is:

1. A communication device installed in a vehicle and comprising:
a first communication section communicating with an interior of a vehicle;
a second communication section communicating with an exterior of the vehicle; and
a processor carrying out control such that communication by the first communication section and communication by the second communication section do not overlap.

2. The communication device of claim 1, wherein the communication device is installed at a movable portion of the vehicle, the first communication section carries out wireless communication with the interior of the vehicle, and the second communication section carries out wireless communication with the exterior of the vehicle.

3. The communication device of claim 1, further comprising:
a wireless power receiver that receives power wirelessly from the interior of the vehicle; and a built-in battery that accumulates power received by the wireless power receiver, and supplies power to the first communication section, the second communication section, and the controller.

4. The communication device of claim 2, further comprising:
a wireless power receiver that receives power wirelessly from the interior of the vehicle; and a built-in battery that accumulates power received by the wireless power receiver, and supplies power to the first communication section, the second communication section, and the controller.

5. The communication device of claim 3, wherein the controller causes communication to be carried out by the second communication section, after communication is carried out by the first communication section and the wireless power receiver receives power.

6. The communication device of claim 5, wherein the controller causes communication to be carried out by the second communication section, after the first communication section carries out communication, and the wireless power receiver receives power, and it is confirmed that voltage of the built-in battery is greater than or equal to a first predetermined value.

7. The communication device of claim 1, wherein the controller transitions to a power-saving mode during a time period in which communication by the first wireless communication section and communication by the second wireless communication section are not carried out.

8. The communication device of claim 2, wherein the controller transitions to a power-saving mode during a time period in which communication by the first wireless communication section and communication by the second wireless communication section are not carried out.

9. The communication device of claim 3, wherein the controller transitions to a power-saving mode during a time period in which communication by the first wireless communication section and communication by the second wireless communication section are not carried out.

10. A wireless power supplying device comprising:
a wireless power supplying section that intermittently supplies power to the communication device of claim 3, from a battery of the vehicle during a time period in which an ignition switch of the vehicle is off.

11. A wireless power supplying device comprising:
a wireless power supplying section that intermittently supplies power to the communication device of claim 5, from a battery of the vehicle during a time period in which an ignition switch of the vehicle is off.

12. A wireless power supplying device comprising:
a wireless power supplying section that intermittently supplies power to the communication device of claim 6, from a battery of the vehicle during a time period in which an ignition switch of the vehicle is off.

13. The wireless power supplying device of claim 10, wherein, in a case in which voltage of the battery of the vehicle is less than a second predetermined value, the wireless power supplying section stops supplying power to the communication device.

14. The wireless power supplying device of claim 11, wherein, in a case in which voltage of the battery of the vehicle is less than a second predetermined value, the wireless power supplying section stops supplying power to the communication device.

15. The wireless power supplying device of claim 12, wherein, in a case in which voltage of the battery of the vehicle is less than a second predetermined value, the wireless power supplying section stops supplying power to the communication device.

16. A communication method causing a computer to, in a communication device installed in a vehicle, execute processings including carrying out control such that communication by a first communication section, which carries out communication with an interior of the vehicle, and communication by a second communication section, which carries out communication with an exterior of the vehicle, do not overlap.

17. A non-transitory, computer-readable storage medium that stores a communication program for causing a computer to, in a communication device installed in a vehicle, execute processings including carrying out control such that communication by a first communication section, which carries out communication with an interior of the vehicle, and communication by a second communication section, which carries out communication with an exterior of the vehicle, do not overlap.
